(19) United States
(12) Patent Application Publication
(10) Pub. No.: US 2008/0207180 A1
(43) Pub. Date: Aug. 28, 2008

(54) METHOD AND APPARATUS FOR LOCATING A MOBILE COMMUNICATIONS DEVICE

(76) Inventor: Mark E. Peters, Chapel Hill, NC (US)

Correspondence Address: DUKE W. YEE, YEE & ASSOCIATES, P.C., P.O. BOX 802333, DALLAS, TX, 75380, US

(21) Appl. No.: 11/680,362

(22) Filed: Feb. 28, 2007

(51) Int. Cl. H04M 3/42

(52) U.S. Cl. 455/414.1

(57) ABSTRACT

A computer implemented method, apparatus, and computer program product for locating a mobile communications device. The process authenticates the communication according to a set of instructions in response to receiving the communication from a user. In response to authenticating the communication, the process activates a signal generator for the mobile communications device.

### BACKGROUND OF THE INVENTION

1. Field of the Invention

The present invention relates generally to an improved data processing system, and in particular, to a method and an apparatus for locating a mobile communications device. Still more particularly, the present invention is related to a computer implemented method, apparatus, and computer usable program product for locating a mobile communications device that has been misplaced while in silent mode.

2. Description of the Related Art

Mobile communications devices, such as cell phones and personal digital assistants (PDAs), notify a user of an incoming call by displaying audio, visual, or tactile signals. For example, a cell phone may ring, display a blinking light, and/or vibrate. A user, however, can control the manner and intensity in which the mobile communications device can signal an incoming call. For example, a user may disable the audible ring tone of a cell phone in certain situations, such as when the user is at a wedding, in a movie theater, or in a meeting at work. Oftentimes, the user will set the phone in silent mode to prevent the cell phone from ringing and vibrating.

Ordinarily, a user can easily locate a misplaced mobile communications device by placing a call to the device. For example, where the mobile communications device is a cell phone or a phone-capable PDA, a user can place a call to the mobile communications device to cause it to audibly ring. A user can then locate the misplaced cell phone by listening for the audible ring tone. However, if the mobile communications device is in silent mode, then the mobile communications device will not ring, and the user is required to search all the various locations in which the mobile communications device could possibly be located. A user may not have the time to spend searching for the mobile communications device if, for example, the user is rushing out the door to catch a flight.

One currently used method for addressing this problem involves the use of a paging mechanism for locating a cordless telephone. A cordless telephone is communicatively coupled to a base station that is generally non-portable. If the cordless phone is misplaced, a user can press the paging button located on the base station in order to cause the cordless phone to generate an audible tone. This solution, however, is impractical for mobile communications devices because a user may misplace the mobile communications device in a separate location from where the base station can be accessed. For example, the base station may be located at home, and the mobile communications device may be misplaced while at the office or at a friend's house.

Another currently used solution for addressing this problem requires a user to affix a sound-generating device to the mobile communications device. A Keyringer™ is a pair of sound-generating devices that can be attached to a cell phone and a set of keys, for example. Pressing a button on one of the Keyringer™ devices causes the other Keyringer™ device to emit an audible sound. However, a user may not wish to employ this solution as it requires the user to affix an obtrusive device to the user's cell phone, ruining the cell phone's sleek profile or preventing the cell phone from fitting in a cell phone holster. Furthermore, in order to activate the Keyringer™ affixed to a misplaced cell phone, the user is required to be in physical possession of the Keyringer™ affixed to the set of keys. If a user has misplaced a purse containing the set of keys and the cell phone, for example, then the user would be unable to employ the Keyringer™ to locate the misplaced items.

The portability of mobile communications devices makes it impractical to utilize a non-portable base station to locate a misplaced mobile communications device. Furthermore, above-mentioned limitations associated with Keyringer™-type devices may dissuade other users from employing such a solution to locate a misplaced mobile communications device.

### BRIEF SUMMARY OF THE INVENTION

The illustrative embodiments described herein provide a method, apparatus, and computer usable program product for managing received calls. The process authenticates a communication according to a set of instructions in response to receiving the communication from a user. In response to authenticating the communication, the process activates a signal generator for the mobile communications device.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network data processing system in which illustrative embodiments may be implemented;

FIG. 2 is a diagram of a mobile phone in which embodiments may be implemented;

FIG. 3 is a block diagram of a mobile phone in accordance with an illustrative embodiment;

FIG. 4 is a block diagram of a data processing system in which illustrative embodiments may be implemented;

FIG. 5 is a block diagram of a flow of data through components of a system for locating a mobile communications device in silent mode in accordance with an illustrative embodiment;

FIG. 6 is a flowchart of a process for locating a mobile communications device in silent mode in accordance with an illustrative embodiment; and

FIGS. 7A and 7B is a flowchart of process for authenticating a communication in accordance with an illustrative embodiment.

### DETAILED DESCRIPTION OF THE INVENTION

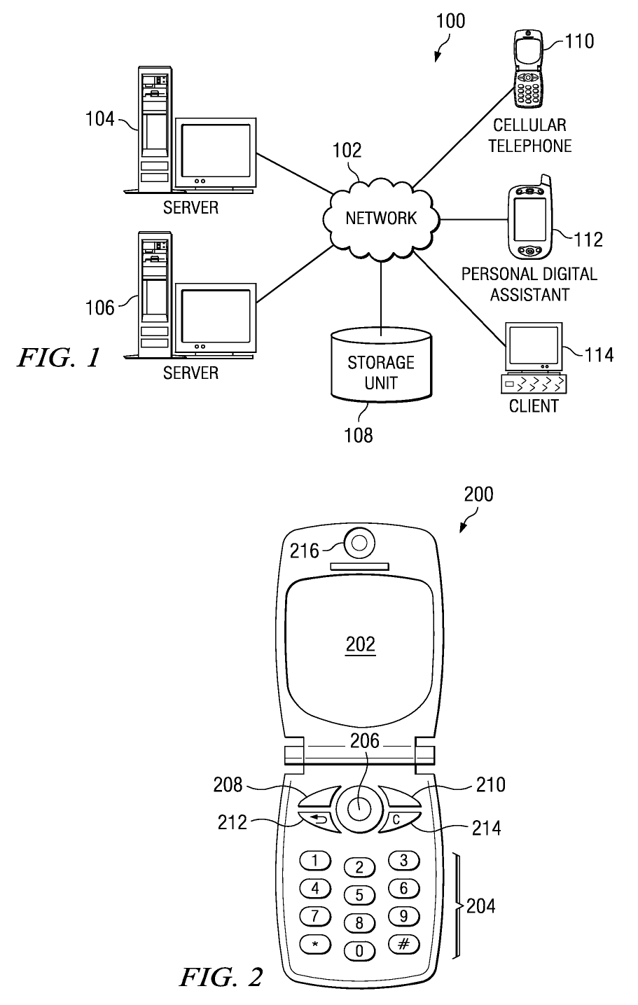

FIGS. 1-4 are exemplary diagrams of data processing environments are provided in which illustrative embodiments may be implemented. It should be appreciated that FIGS. 1-4 are only exemplary and are not intended to assert or imply any limitation with regard to the environments in which different embodiments may be implemented. Many modifications to the depicted environments may be made.

With reference now to the figures, FIG. 1 depicts a pictorial representation of a network of data processing system in which illustrative embodiments may be implemented. Network data processing system 100 is a network of computing devices in which embodiments may be implemented. Network data processing system 100 contains network 102, which is the medium used to provide communications links between various devices and computers connected together within network data processing system 100. Network 102 may include connections, such as wire, wireless communication links, or fiber optic cables. The depicted example in FIG. 1 is not meant to imply architectural limitations. For example, data processing system 100 also may be a network of cellular telephone subscribers and users.

In the depicted example, server 104 and server 106 connect to network 102 along with storage unit 108. In addition, cellular telephone 110, PDA 112, and client 114 are coupled to network 102. Cellular telephone 110, PDA 112, and client 114 are examples of devices that may be utilized for transmitting or receiving information and/or data in a network, such as network 102. Client 114 may be, for example, a personal computer, a laptop, a tablet PC, a network computer, a hardwired telephone, a voice over internet communications device, or any other communications device or computing device known or available and usable to transmit information and/or data. In this depicted example, server 104 may provide data, such as boot files, operating system images, and applications to cellular telephone 110, PDA 112, and client 114. Cellular telephone 110, PDA 112, and client 114 are coupled to server 104 through network 102 in this example. Network data processing system 100 may include additional servers, clients, computing devices, and other communications devices for transmitting or receiving information and/or data.

In the illustrative embodiment, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational, and other computer systems that route data and messages. Of course, network data processing system 100 also may be implemented as a number of different types of networks, such as, for example, an intranet, a local area network (LAN), a wide area network (WAN), a telephone network, or a satellite network. FIG. 1 is intended as an example, and not as an architectural limitation for different embodiments.

With reference now to FIG. 2, a mobile telephone is depicted in which the illustrative embodiments may be implemented. Mobile phone 200 is a mobile phone, such as cellular telephone 110 in FIG. 1. Mobile phone 200 includes screen 202, which is capable of displaying pictures and text. Additionally, mobile phone 200 also includes numeric keypad 204, joystick 206, and buttons 208, 210, 212, and 214 placed around the joystick 206. These buttons are used to initiate various functions in mobile phone 200. These functions include for example, activating a menu, displaying a calendar, or initiating a call. Mobile phone 200 also includes camera 216, which may be used to take pictures or videos depending on the implementation.

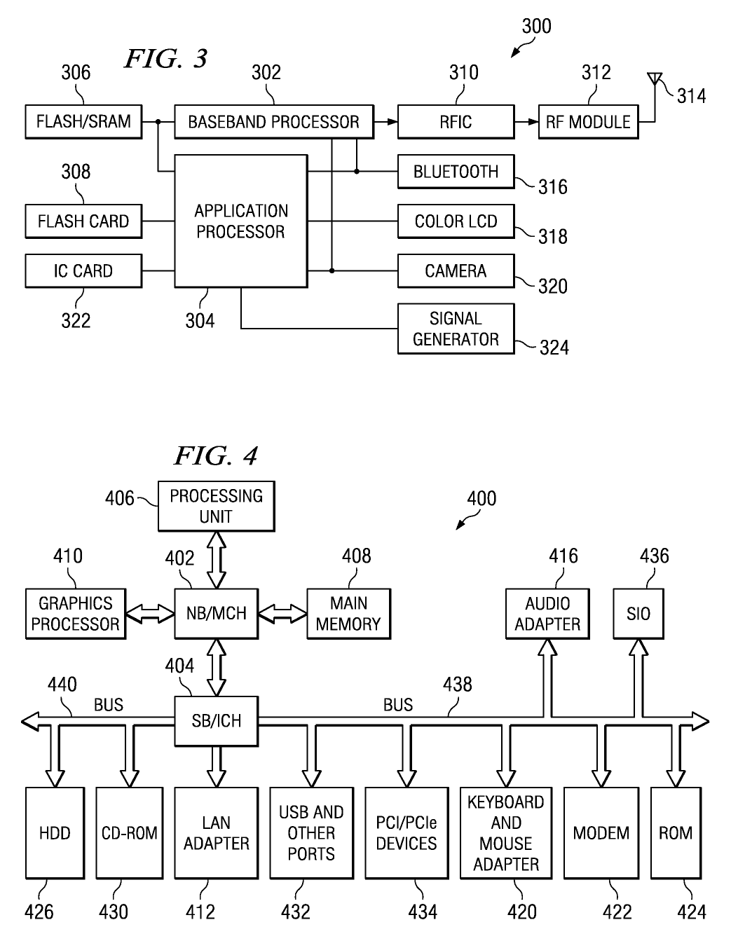

Turning next to FIG. 3, a block diagram of a mobile phone is depicted in accordance with an illustrative embodiment. Mobile phone 300 includes baseband processor 302, application processor 304, flash/static random access memory (SRAM) 306, flash card 308, radio frequency integrated circuit (RFIC) 310, radio frequency (RF) module 312, antenna 314, Bluetooth® unit 316, color liquid crystal display (LCD) 318, camera 320, and IC card 322.

Baseband processor 302 provides for receiver and transmitter operations and is also referred to as a transceiver. In particular, baseband processor 302 handles the entire audio, signal, and data processing needed to receive and send data using radio frequency transmissions or Bluetooth® transmissions. Application processor 304 provides the processing power for other functions within mobile phone 300. For example, calculators, calendars, alarms, camera functions, and directories are provided through application processor 304. Flash/SRAM 306 is a storage device in which various instructions for providing the functions within mobile phone 300 are located and provide upgrades. Flash card 308 is a storage device in which user data and applications may be stored. An example of flash card 308 is a secure digital card.

A pathway for the transmission of voice and other types of data is through RFIC 310. Additionally, short range transmissions may be sent or received through Bluetooth® unit 316. Bluetooth® unit 316 conforms to Bluetooth® wireless specification, which defines the link layer and application layer for product developers. Both of these transmissions are made through antenna 314 in this illustrative example.

Color LCD 318 provides a display for pictures and other data for mobile phone 300. Camera 320, in this example, is a complementary metal oxide semiconductor (CMOS) camera which may be built into camera phone 300 or connected to camera phone 300 as a module, such as an IC card 322. IC card 322 also may contain other application specific functions, such as a global positioning system (GPS) or other functions, such as a modem or additional memory.

Camera 320 forms the camera module of mobile phone 300, while the other components form the digital phone module of mobile phone 300 in these illustrative examples.

Signal generator 324 is a component of mobile phone 300 operable to generate audio, visual, and/or tactile signals for presenting notifications to a user. For example, signal generator 324 may generate a signal to notify a user of an incoming call or text message. Instructions or circuits may be added to mobile phone 300 to control the operation of signal generator 324.

With reference now to FIG. 4, a block diagram of a data processing system is shown in which illustrative embodiments may be implemented. Data processing system 400 is an example of a computing device, such as server 104, PDA 112, and client 114 in FIG. 1, in which computer usable code or instructions implementing the processes may be located for the illustrative embodiments.

In the depicted example, data processing system 400 employs a hub architecture including a north bridge and memory controller hub (MCH) 402 and a south bridge and input/output (I/O) controller hub (ICH) 404. Processing unit 406, main memory 408, and graphics processor 410 are coupled to north bridge and memory controller hub 402. Graphics processor 410 may be coupled to the MCH through an accelerated graphics port (AGP), for example.

In the depicted example, local area network (LAN) adapter 412 is coupled to south bridge and I/O controller hub 404 and audio adapter 416, keyboard and mouse adapter 420, modem 422, read only memory (ROM) 424, universal serial bus (USB) ports and other communications ports 432, and PCI/PCIe devices 434 are coupled to south bridge and I/O controller hub 404 through bus 438, and hard disk drive (HDD) 426 and CD-ROM drive 430 are coupled to south bridge and I/O controller hub 404 through bus 440. PCI/PCIe devices may include, for example, Ethernet adapters, add-in cards, and PC cards for notebook computers. PCI uses a card bus controller, while PCIe does not. ROM 424 may be, for example, a flash binary input/output system (BIOS). Hard disk drive 426 and CD-ROM drive 430 may use, for example, an integrated drive electronics (IDE) or serial advanced technology attachment (SATA) interface. A super I/O (SIO) device 436 may be coupled to south bridge and I/O controller hub 404.

An operating system runs on processing unit 406 and coordinates and provides control of various components within data processing system 400 in FIG. 4. The operating system may be a commercially available operating system such as Microsoft® Windows® XP. Microsoft and Windows are trademarks of Microsoft Corporation in the United States, other countries, or both. The operating system may also be a retail specific operating system, such as IBM® 4690 Operating System®. An object oriented programming system, such as the Java™ programming system, may run in conjunction with the operating system and provides calls to the operating system from Java programs or applications executing on data processing system 200. Java™ and all Java™-based trademarks are trademarks of Sun Microsystems, Inc. in the United States, other countries, or both.

Instructions for the operating system, the object-oriented programming system, and applications or programs are located on storage devices, such as hard disk drive 426, and may be loaded into main memory 408 for execution by processing unit 406. The processes of the illustrative embodiments may be performed by processing unit 406 using computer implemented instructions, which may be located in a memory such as, for example, main memory 408, read only memory 424, or in one or more peripheral devices.

In some illustrative examples, data processing system 400 may be a personal digital assistant (PDA), which is generally configured with flash memory to provide non-volatile memory for storing operating system files and/or user-generated data. A bus system may be comprised of one or more buses, such as a system bus, an I/O bus or a PCI bus. Of course the bus system may be implemented using any type of communications fabric or architecture that provides for a transfer of data between different components or devices attached to the fabric or architecture. A communications unit may include one or more devices used to transmit and receive data, such as modem 422 or network (LAN) adapter 412 in FIG. 4. A memory may be, for example, main memory 408 or a cache such as found in north bridge and memory controller hub 402 in FIG. 2. A processing unit may include one or more processors or CPUs. The depicted examples in FIGS. 1-4 and above-described examples are not meant to imply architectural limitations. For example, data processing system 400 also may be a tablet computer, laptop computer, or telephone device in addition to taking the form of a PDA.

The hardware in FIGS. 1-4 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system.

The illustrative embodiments described herein provide a method, apparatus, and computer usable program product for locating a mobile communications device in a silent mode. A silent mode is a mode of operation in which the mobile communications device does not generate any sounds. In addition, the silent mode may also prevent a mobile communications device from generating vibrations. In one embodiment, in response to receiving a communication from a user, the process authenticates the communication according to a set of instructions. Upon authentication of the communication, the process activates a signal generator in the mobile communications device for a predefined period of time.

The communication, which can be, for example, a phone call, a text message, an email, or a pre-configured message, can be authenticated by confirming the origin of the communication or the content of the communication. Once the communication has been authenticated, then the user sending the communication may be provided with information usable for locating the mobile communications device. Additionally, the user may also modify a configuration of the mobile communications device after the communication has been authenticated.

In another embodiment, the process may authenticate the communication by storing a call identifier of a first call in response to receiving the first call. Thereafter, in response to receiving a subsequent call within a predefined period of time, the process matches the call identifier of the first call with a call identifier of the subsequent call to identify a designated communications device. In response to identifying the designated communications device, the process enables a signal generator in the mobile communications device for a predefined period of time. A signal generator is a component of a mobile communications device, such as signal generator 324 in FIG. 3, which is operable to generate audible, visual, and/or tactile signals to present notifications to a user operating a mobile communications device.

In alternate embodiments, before enabling a signal generator in the mobile communications device, the process may also require a user to provide a password. In addition, the process may also require that the communications device from which the first and subsequent calls have been received is one of a set of predetermined communications devices.

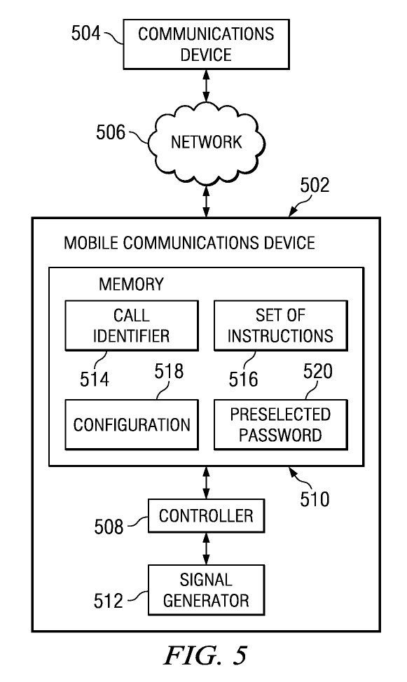

Turning now to FIG. 5, a block diagram of the flow of data through components of a system for locating a mobile communications device is depicted in accordance with an illustrative embodiment. In this illustrative embodiment as depicted in FIG. 5, mobile communications device 502 is coupled to communications device 504 via network 506. Network 506 is a network, such as network 102 in FIG. 1. Mobile communications device 502 is a mobile communications device, such as cellular telephone 110 and personal digital assistant 112 in FIG. 1. Communications device 504 is any device capable of transmitting and/or receiving data, such as, for example, client 114 in FIG. 1, a traditional hardwired telephone, a voice over internet telephone, a cellular telephone, a PDA, a personal computer, a laptop computer, a tablet PC, or any other known or available communications device.

Mobile communications device 502 includes controller 508 that is coupled to memory 510 and signal generator 512. Controller 508 is operable to process a communication received from a user utilizing communications device 504 in order to allow the user to enable and/or activate signal generator 512. A communication, which may also be generically referred to as a “call,” received from communications device 504 can be, for example, a phone call, a text message, an email message, a Bluetooth® signal, a preconfigured message sent from a software program operating in conjunction with mobile communications device 502, or any other form of communication known or available.

Signal generator 512 is a signal generator such as signal generator 324 in FIG. 3. Activation of signal generator 512 temporarily disables or changes the silent mode of mobile communications device 502 by causing signal generator 512 to audibly ring, vibrate, display a flashing light, or display any combination of signals for a predefined amount of time. Controller 508 can be a software component, one or more hardware components, or a combination of software and hardware. Signal generator 512 is any device or component of a device that can generate audio, visual, or tactile signals serving as notifications to a user of mobile communications device 502.

Memory 510 is any type of memory, including but not limited to flash/SRAM 306 and flash card 308 in FIG. 3. Memory 510 is usable by controller 508 in order to store a call identifier, such as call identifier 514 which identifies the communication received from communications device 504. Call identifier 514 is any form of identifier associated with a communication. For example, if the communication is a phone call or text message from a cell phone, then call identifier 514 may be a telephone number. Where the communication is an instant message, then call identifier 514 may be the unique screen name from which the communication originated. Similarly, if the communication is an email, then call identifier 514 may be an email address. The communication may also be a data signal storing a simple command, instruction, or message. The content of the data signal may be automatically generated from a computer program application working in conjunction with mobile communications device 502. The computer program application may be, for example, prepackaged software accompanying the purchase of mobile communications device 502 usable to sync mobile communications device 502 with a personal computer. In this illustrative example where the communication is a data signal generated from a personal computer, then call identifier 514 may be, for example, an IP address, the name of the computer from which the signal was sent, or a Bluetooth® partner name. Once stored in memory 510, controller 508 may reference call identifier 514 in order to identify a designated communications device or authenticate a communication.

In an illustrative embodiment, controller 508 activates signal generator 512 upon receiving and authenticating a communication according to a set of instructions. The set of instructions may require controller 508 to authenticate a communication by confirming the origin of the communication and/or by confirming the content of the communication. Authenticating a communication by confirming the origin of the communication consists of having controller 508 verify that the communication originated from at least one of a set of predetermined communications devices.

For example, a user may select the user's work number, home telephone number, and spouse's cell phone number as the set of predetermined communications devices. After receiving a communication from communications device 504 but before activating signal generator 512, controller 508 must confirm that communications device 504 is a device from the set of predetermined communications devices. For example, controller 508 may confirm that communications device 504 is a device from the set of predetermined devices by comparing a call identifier relating to the communication with the call identifiers of the set of predetermined communications devices stored in memory 510. In addition, the set of predetermined communications devices may include an instant messenger screen name, an email address, or an IP address from which a communication can be sent.

Authenticating a communication by confirming the content of the communication may consist of verifying that the communication contains a preconfigured message stored in the set of instructions. For example, a user may select the following preconfigured message, “Please ring, oh little lost phone of mine.” Thus, in order for controller 508 to authenticate the communication received from communications device 504, an email or text message to mobile communications device must contain that preconfigured message. If the communication is a phone call, then the user sending the communication may verbally recite the preconfigured message and, once confirmed by controller 508, the communication is authenticated and controller 508 can activate signal generator 512.

In another embodiment, the communication can be a preconfigured message automatically generated from a software application executing on a computer, a PDA, a cell phone, or other similar computing device. The software application may be a program provided to a user along with mobile communications device, such as software commonly packaged with a cell phone or PDA to enable a user to sync up with a laptop or desktop computer. The software application may also be an Internet-based application offered by a cell phone service provider and accessible via a Web browser. In any event, the user may be presented with a graphical user interface populated with icons, for example, one of which automatically generates a preconfigured message to activate signal generator 512 once a user selects the icon. In alternate embodiments, a user can enter a selection at any type of user interface including, but not limited to a command line interface or a menu-driven interface. For example, a user can type a command at a command line interface by utilizing a computer keyboard, a phone keypad, or a user can select a menu option in a menu-driven interface.

In addition, once controller 508 has authenticated the communication, controller 508 may return information to a user operating communications device 504, which describes the location in which the mobile communications device may be found. For example, controller 508 may identify the various cell phone towers with which mobile communications device 502 is communicating. Controller 508 may then provide a user utilizing communications device 504 a map or description of the location of mobile communications device 502. Similarly, if mobile communications device 502 is a GPS (global positioning system) enabled device, then controller 508 may also provide a user a map or description of the location of mobile communications device 502.

In another illustrative example, the communication can be sent from a user operating a Bluetooth® enabled device. In particular, the communication may be a data signal transmitted via a Bluetooth® connection between communications device 504 and mobile communications device 502. Communications device 504 can be, for example, a computer, a PDA, a cell phone, or a hands-free Bluetooth® headset. Controller 508 can cause mobile communications device 502 to generate a signal once it has received a data signal from the Bluetooth®-enabled device. For example, a user operating a desktop computer, a laptop computer, a tablet PC, or a similar computing device, may utilize a software application that displays a list of all Bluetooth® devices with which the computing device has established a wireless connection. The user may then select the icon corresponding to mobile communications device 502 to generate a data signal for receipt by mobile communications device 502. Receipt of the data signal activates signal generator 512.

Once activated, controller 508 may limit the activation of signal generator 512 to a predefined period of time. The predefined period of time may be calculated based upon the lapse of time or the completion of a predefined operation. For example, controller 508 may activate signal generator 512 so that signal generator 512 produces twenty audible signals before signal generator 512 is deactivated.

In another illustrative embodiment, controller 508 may authenticate the communication by receiving a series of calls from a communications device and identifying the communications device as a designated communications device. A series of calls is a user-defined number of calls that can be two or more calls. For example, one user may prefer to have controller 508 activate signal generator 512 after having placed two subsequent calls within a predefined period of time. Another user may prefer controller 508 to activate signal generator 512 upon placing four successive calls within a predefined period of time because, for example, the user's spouse tends to call the user's mobile communications device twice in a row in quick succession when the spouse has an urgent matter to discuss. A designated communications device is a communications device, such as communications device 504, which is operable to cause controller 508 to enable and/or activate signal generator 512. Controller 508 identifies the designated communications device according to set of instructions 516 which may be stored within memory 510. In an illustrative embodiment, set of instructions 516 is a collection of rules dictating, among other things, the manner in which controller 508 may identify a designated communications device. For example, set of instructions 516 may allow controller 508 to identify a designated communications device when controller 508 receives a predetermined number of phone calls from a single communications device within a predefined period of time. In one illustrative embodiment where mobile communications device 502 is a cell phone and communications device 504 is a hardwired telephone, set of instructions 516 may dictate that controller 508 identifies a designated communications device upon receiving two calls from communications device 504 within a predefined period of time, such as a span of thirty seconds. Thus, after a user realizes that mobile communications device 502 has been misplaced and is in silent mode, the user places a first call to mobile communications device 502 from communications device 504. Controller 508 receives the first call and stores call identifier 514 in memory 510. In this example, the call identifier is the telephone number of communications device 504.

Thereafter, the user places a subsequent call to mobile communications device 502 from communications device 504. Upon receiving the subsequent call within the predefined period of time, controller 508 compares the call identifier of the subsequent call with the call identifier of the first call that is stored in memory 510. If the call identifier of the first call matches the call identifier of the subsequent call, then in this simple embodiment, controller 508 identifies communications device 504 as the designated communications device. Upon identifying a designated communications device, controller 508 then enables signal generator 512.

Once the designated communications device has been identified and signal generator 512 is enabled, if controller 508 receives a subsequent call from the designated communications device within another predefined period of time, such as within another thirty second period, then controller 508 will activate signal generator 512. Activating signal generator 512 causes signal generator to generate an audible tone, display a source of light, and/or vibrate. By providing set of instructions 516 to specify the circumstances in which a series of consecutive calls can cause controller 508 to enable and/or activate signal generator 512, a single caller will not likely inadvertently trigger the ringing of mobile communications device 502.

In an alternative embodiment, the set of instructions may further require that a communication originating from a designated communications device matches at least one of a set of predetermined communications devices before controller 508 can activate signal generator 512. For example, a user may specify a list of predetermined communications devices from which a communication can be sent. The list of predetermined communications devices may include the user's home phone, work phone, or spouse's cell phone. Thus, in order for controller 508 to enable signal generator 512, controller 508 is required to confirm that that communication originated from a communications device that is included in the set of predetermined communications devices. Controller 508 may accomplish this by comparing the call identifier of the first and subsequent call with the call identifiers of the set of predetermined communications devices stored in memory 510. In addition, the set of predetermined communications devices may include an email address, an instant message screen name, or an IP address. In one illustrative embodiment, the set of predetermined communications devices may be defined in configuration 518.

In another embodiment, controller 508 cannot enable signal generator 512 until a user of communications device 504 supplies a correct password. For example, a user can supply the password by typing it in a text-based communication to mobile communications device 502. In alternate examples, the user can speak the password to a voice recognition component of controller 508, or provide the password by pressing the buttons of a cell phone or hardwired telephone to generate a dual-tone multi-frequency signal. Thus, upon identifying the designated communications device, controller 508 may prompt a user to provide a password. Once controller 508 confirms the password by matching the user-supplied password with a pre-selected password, such as pre-selected password 520, controller 508 may enable signal generator 512. The pre-selected password can be, for example, a word, a phrase, a number, or a series of alphanumeric characters stored in memory 510.

In an illustrative embodiment, once controller 508 has authenticated a communication, a user operating the designated communications device may be permitted to modify configuration 518 of mobile communications device 502. In these illustrative embodiments, configuration 518 of mobile communications device 502 is a collection of options selectable for controlling the operation of mobile communications device 502. Configuration 518 may include, for example, an option for setting the length of time during which mobile communications device 502 will ring upon activation of signal generator 512, or specifying a new password to modify configuration 518 of mobile communications device 502. In addition, modifying configuration 518 may allow a user to specify a new set of predetermined communications devices capable of causing controller 508 to activate signal generator 512. Further, modifying configuration 518 can allow the user to lock mobile communications device 502 to prevent unauthorized use or limit the devices to which mobile communications device 502 can communicate.

The manner in which the user sending the communication could modify configuration 518 of mobile communications device 502 depends upon the type of device from which the communication is sent. For example, if the communications device 504 is a hardwired telephone, then in one embodiment, the user can access an audio-based menu, such as the menus utilized by automated phone systems. The user could then navigate the audio-based menu by responding to one or more prompts by pressing the various buttons on the telephone. In another illustrative example, where communications device 504 is, for example, a cell phone, such as cell phone 200 in FIG. 2, a PDA, or a computer, then the user can navigate a visual menu presented on a graphical user interface in order to modify the configuration of mobile communications device 502.

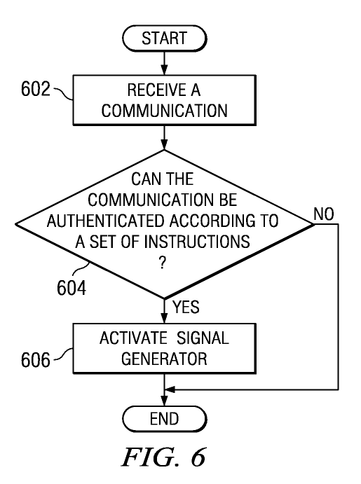

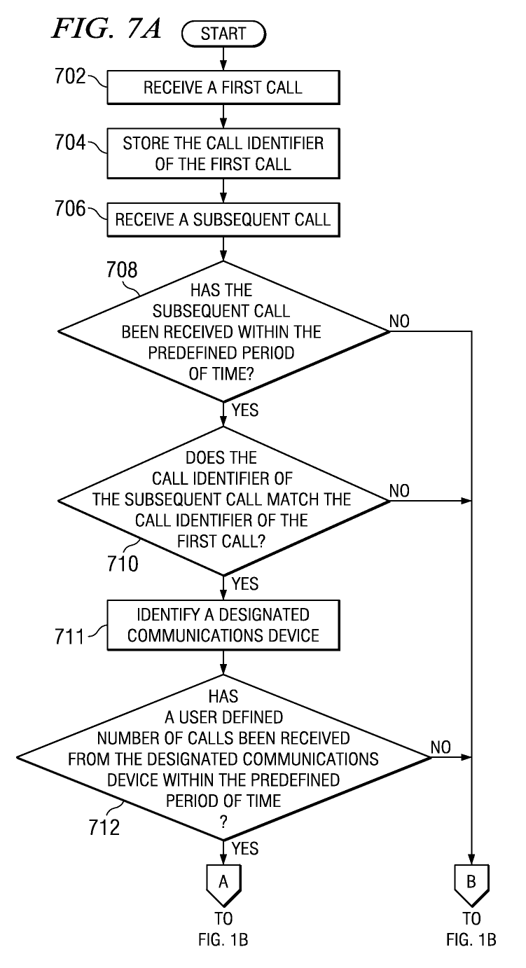

Turning now to FIG. 6, a flowchart of a second process for locating a mobile communications device in silent mode is depicted in accordance with an illustrative embodiment. In this illustrative embodiment in FIG. 6, the process may be performed by a software component, such as controller 508 in FIG. 5.

The process begins by receiving a communication from a user (step 602). The process then makes the determination as to whether the communication can be authenticated according to a set of instructions (step 604). If the process makes the determination that the communication can be authenticated according to the set of instructions (yes output to step 604), then the process activates the signal generator (step 606) and the process terminates thereafter.

Returning now to step 604, if the process makes the determination that the communication cannot be authenticated according to the set of instructions (no output to step 604), then the process terminates thereafter.

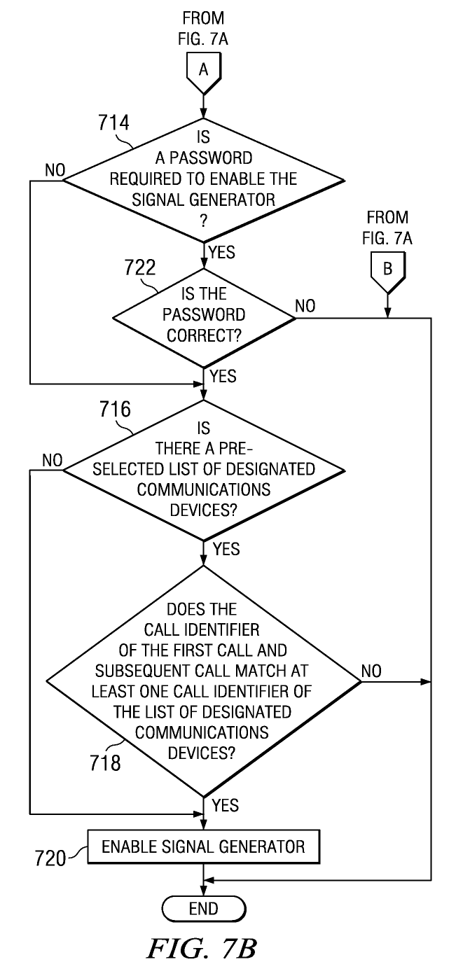

Turning now to FIGS. 7A and 7B, a flowchart of a first process for locating a mobile communications device in silent mode is depicted in accordance with an illustrative embodiment. In this illustrative embodiment in FIGS. 7A and 7B, the process may be performed by a software component, such as controller 508 in FIG. 5.

The process begins by receiving a first call (step 702) and storing a call identifier of the first call (step 704). Thereafter, the process receives a second call (step 706). The process then makes the determination as to whether the subsequent call has been received within the predefined period of time after having received the first call (step 708).

If the process has received the subsequent call within the predefined period of time (yes output to step 708), then the process makes the determination as to whether the call identifier of the subsequent call matches the call identifier of the first call (step 710). If the process determines that the call identifier of the subsequent call matches the call identifier of the first call, then the process identifies a designated communications device (step 711). Thereafter, the process makes the determination as to whether a user-defined number of calls has been received from the designated communications device within the predefined period of time (step 712).

If the process has received a user-defined number of calls from the designated communications device within the predefined period of time (yes output to step 712), then the process makes the determination as to whether a user-provided password is required in order to enable the signal generator (step 714).

If the process makes the determination that a user-provided password is not required to enable the signal generator (no output to step 714), then the process makes the determination as to whether there is a pre-selected list of designated communications devices (step 716). If the process makes the determination that there is a predetermined list of designated communications devices (yes output to step 716), then the process makes the determination as to whether the call identifier of the first call and the subsequent call match at least one call identifier of the list of designated communications devices (step 718).

If the process makes the determination that the call identifiers of the first and subsequent calls match at least one call identifier of a device in the set of designated communications devices (yes output to step 718), then the process enables the signal generator (step 720). However, if the process makes the determination that the call identifiers of the first and subsequent calls fail to match at least one call identifier of a device in the set of designated communications devices (no output to step 718), then the process terminates thereafter.

Returning now to step 708, if the process makes the determination that the subsequent call has not been received within the predefined period of time (no output to step 708), then the process terminates thereafter.

Returning now to step 710, if the process makes the determination that the call identifier of the subsequent call does not match the call identifier of the first call (no output to step 710), then the process terminates thereafter.

Returning now to step 712, if the process makes the determination that a call has not been received from the designated communications device within the predefined period of time (no output to step 712), then the process terminates thereafter.

Returning now to step 714, if the process makes the determination that a password is required to enable the signal generator (yes output to step 714), then the process makes the determination as to whether the password is correct (step 722). If the user-provided password is correct, then the process continues to step 716. However, if the process makes the determination that the user-provided password is not correct, then the process terminates thereafter.

The illustrative embodiments described herein provide a method, apparatus, and computer usable program product for managing received calls. The process authenticates the communication according to a set of instructions in response to receiving a communication from a user. In response to authenticating the communication, the process activates a signal generator of the mobile communications device for a predefined period of time.

Using the above-mentioned methods, a user can quickly and easily locate a mobile communications device that has been misplaced while the device is in silent mode. The user saves time by not having to thoroughly search each and every location in which the mobile communications device may be located. In addition, the user can activate a ringer of the mobile communications device by utilizing practically any available communications device, such as a computer, a telephone, a cell phone, or a PDA.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or a solid state memory, a magnetic tape, a removable computer diskette, a random access memory (RAM), a read-only memory (ROM), a rigid magnetic disk, and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem, and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for locating a mobile communications device, the computer implemented method comprising:
responsive to receiving a communication from a user, authenticating the communication according to a set of instructions;
responsive to authenticating the communication, activating a signal generator for the mobile communications device.

2. The computer implemented method of claim 1, wherein the signal generator for the mobile communications device is activated for a predefined period of time.

3. The computer implemented method of claim 1, further comprising:
responsive to authenticating the communication, permitting a user to modify a configuration for the mobile communications device.

4. The computer implemented method of claim 1, further comprising:
responsive to authenticating the communication, providing a user information indicating the location of the mobile communications device.

5. The computer implemented method of claim 1, wherein the communication is at least one of a phone call, a text message, an email message, and a data signal generated from a computer program.

6. The computer implemented method of claim 1, wherein the communication is authenticated by confirming at least one of an origin of the communication and a content of the communication.

7. The computer implemented method of claim 1, wherein the step of authenticating the communication according to the set of instructions comprises:
responsive to receiving a first call, storing a call identifier of the first call;
responsive to receiving a subsequent call within a predefined period of time, comparing a call identifier for the first call and a call identifier for the subsequent call;
if a match is present in response to the comparison of the first call identifier and the call identifier of the subsequent call, identifying a designated communications device; and
responsive to identifying the designated communications device, enabling a signal generator for the mobile communications device.

8. The computer implemented method of claim 7, wherein enabling the signal generator further comprises:
prompting a user for a password; and
responsive to confirming the password, enabling the signal generator for the mobile communications device.

9. The computer implemented method of claim 7, wherein enabling the signal generator further comprises:
receiving a call from the designated communications device within a predefined period of time; and
responsive to receiving the call from the designated communications device, enabling the signal generator.

10. The computer implemented method of claim 7, wherein the designated communications device is one of a set of predetermined communications devices.

11. A computer program product comprising:
a computer usable medium having computer usable program code for locating a mobile communications device, the computer program product comprising:
computer usable program code for authenticating a communication according to a set of instructions in response to receiving the communication from a user; and
computer usable program code for activating a signal generator of the mobile communications device for a predefined period of time in response to authenticating the communication.

12. The computer program product of claim 11, wherein the signal generator of the mobile communications device is activated for a predefined period of time.

13. The computer program product of claim 11, wherein the communication is at least one of a phone call, a text message, an email message, a data signal generated from a computer program.

14. The computer program product of claim 11, wherein the communication is authenticated by computer usable program code for confirming at least one of the origin of the communication and the content of the communication.

15. The computer program product of claim 11, wherein the computer usable program code for authenticating the communication according to the set of instructions further comprises:
computer usable program code for storing a call identifier of a first call in response to receiving the first call;
computer usable program code for comparing the call identifier of the first call with a call identifier of a subsequent call in response to receiving the subsequent call within a predefined period of time;
computer usable program code for identifying a designated communications device if a match is present in response to the comparison of the first call identifier and the call identifier of the subsequent call; and
computer usable program code for enabling a signal generator of the mobile communications device for a predefined period of time in response to identifying the designated communications device.

16. The computer program product of claim 15, wherein the computer usable program code for enabling the signal generator further comprises:
computer usable program code for prompting a user for a password; and
computer usable program code for enabling the signal generator for the mobile communications device in response to confirming the password.

17. The computer program product of claim 15, wherein the computer usable program code for enabling the signal generator further comprises:
computer usable program code for receiving a call from the designated communications device within a predefined period of time; and
computer usable program code for enabling the signal generator in response to receiving the call from the designated communications device.

18. The computer program product program product of claim 15, wherein the designated communications device is one of a set of predetermined communications devices.

19. A system comprising:
a communications device communicatively coupled to a network, wherein the communications device is operable by a user to generate a communication;
a mobile communications device coupled to the network, wherein the mobile communications device authenticates the communication generated by the communications device and activates a signal generator for the mobile communications device in response to authenticating the communication.

20. An apparatus comprising:
a signal generator;
a memory comprising computer usable program code; and
a controller coupled to the memory, wherein the controller executes the computer usable program code to authenticate a communication according to a set of instructions in response to receiving the communication from a user, and activate the signal generator in response to authenticating the communication.
